(19) United States
(12) Patent Application Publication
(10) Pub. No.: US 2008/0307449 A1
(43) Pub. Date: Dec. 11, 2008

(54) Rotating data carrier with detector wafer

(75) Inventors: Anatoli STOBBE, Barsinghausen (DE); Werner KNOP, Wennigsen (DE)

Correspondence Address: COLLARD & ROE, P.C., 1077 NORTHERN BOULEVARD, ROSLYN, NY, 11576, US

(73) Assignee: ASTRA Gesellschaft for Asset Management mbH & CO. KG

(21) Appl. No.: 12/157,101

(22) Filed: Jun. 6, 2008

(30) Foreign Application Priority Data
Jun. 7, 2007 (DE) 10 2007 026 984.8

(51) Int. Cl. G11B 7/24; G11B 23/03

(52) U.S. Cl. 720/718; 720/719

(57) ABSTRACT

A rotating data carrier with detector wafer is described.

The detector wafer consists of a chip and a magnetic coupling loop connected to the chip, which loop is arranged on the central uncoated region of the data carrier.

The invention relates to a rotating data carrier with a detector wafer according to the precharacterizing clause of claim 1.

Rotating data carriers with a metal coating are known as CDs, DVDs, Blu-ray discs and HD DVDs. They are used, amongst other things, for storing copyright-protected works, such as computer programs, data collections and works of literature, art, image, music and film which, to some extent, are of considerable value.

In order to limit losses from retail companies and rental outlets or facilitate the registration of bought or rented items, it is known per se to provide items with security tags which are deactivated in the till or rental area after the payment of the purchase or rental price and/or to use machine-readable inventory tags which enable the automatic registration of bought or rented items.

Optically-readable barcodes for registration in the till or rental area and one-bit capture systems as security against theft in the exit area are currently standard. Furthermore radio systems are increasingly being used, which even allow registration or security against theft over a larger distance when no optical visual contact exists between the detector wafer on the item and a reader device. However, in this case a condition for a satisfactory range is a substantially undamped environment of the radio-supported detector wafer on the item.

Range problems occur, however, when using radio-supported detector wafers on the data carrier as a result of the coating on rotating data carriers which is formed as a metallic coating for optical sensors, which coating is electrically conductive at the same time.

The object of the invention is, for radio-supported detector wafers on a rotating data carrier with a metallic coating, to create the conditions for a necessary increase in the reading range.

This object is achieved for a rotating data carrier with a detector wafer according to the precharacterizing clause of claim 1 by means of the features of this claim 1.

Further developments and advantageous configurations result from the subclaims.

The invention is based on the consideration that an inductive coupling loop outweighs the magnetic components of the electromagnetic alternating field in the near field and therefore the propagation of the electromagnetic alternating field is less impeded in the near field by metallic objects (in the present case, the metallic coating of the data carrier) than when using an antenna which preferably radiates the electrical components.

The detector wafer can be arranged on a plastic film which is bonded to the data carrier.

As a result, any desired rotating data carrier can be equipped in accordance with the invention without intervening in its manufacturing process and without impairing conventional use.

The coupling loop of the detector wafer can be coupled to an amplifying antenna.

Coupling to an amplifying antenna which acts as a purely passive component, the reading range of the detector plate can be increased considerably.

The amplifying antenna can be configured as a dipole antenna.

The use of a dipole antenna allows, by means of its design, in particular its length and shape, an exact adjustment to be carried out, in a simple manner, of the resonance frequency of the antenna to the working frequency of the detector wafer and reader device, so that the antenna can radiate with the maximum degree of efficacy.

The dipole antenna is preferably arranged in a case or packaging of the data carrier.

The configuration of the case or packaging can create a spacing between the transmitter of the dipole antenna and the coating of the data carrier, which spacing reduces detuning of the dipole antenna and so enables a satisfactory reading range of the detector wafer. Furthermore, as an option, a small reading range of the detector wafer without case or packaging and a high reading range of the detector wafer with case or packaging is enabled.

Preferably, the dipole antenna is located so as not to be visible on a reverse side of a printed inlay in the case, on the reverse side of the holder for the data carrier in the case or on an antenna carrier inserted between the holder for the data carrier and the printed inlay in the case.

In addition to a mechanical spacing from the coating of the data carrier, which effects a reduction in detuning as a result of the coating, the dipole antenna is also arranged optically hidden, so that without opening the case it is not possible to determine whether the data carrier with the case is equipped with the invention or not.

In a preferred configuration, the dipole antenna consists of a coupling region running in the centre or close to the centre of the case or packaging and transmitters running along the edges of the case or packaging.

So an electrical coupling takes place in the coupling region of the dipole antenna between the coupling loop of the detector wafer and the low-resistance region of the dipole antenna, the regions of the dipole antenna which run parallel to the coating of the data carrier predominantly act as a feed line and electrical extension of the transmitters and the transmitters which run along the edges of the case or packaging finally constitute the transmitting elements of the dipole antenna which are tuned to the resonance frequency.

Alternatively, the amplifying antenna can be formed as a slot antenna, the slot being formed by the central uncoated region of the data carrier itself.

A slot antenna is characterized per se by a narrow slot in an electrically conductive environment, the length of the slot corresponding to a single quarter wavelength or multiple of a quarter wavelength of the resonance frequency of the slot antenna. In the present case, the electrically conductive environment is formed by the metallic coating of the data carrier itself and the slot is widened to the circular uncoated centre of the data carrier.

This design, which is predetermined by the norm for data carriers, necessarily sets the influenceable limits of the resonance frequency of the slot antenna formed by the coating of the data carrier. However, the shape of the slot as a circular uncoated centre already gives an increased bandwidth of the slot antenna in comparison to a narrow oval slot. Furthermore, the resonance frequency of the slot antenna can also be influenced within limits by means of the design and degree of coupling of the coupling loop.

Experiments and calculations have shown that, in spite of a remaining mismatch in the frequency range between 800 and 1000 MHz, a reading range can be achieved that corresponds to at least half of the reading range of a coupling with a previously described dipole antenna and is considerably higher than the reading range of the coupling loop on its own.

The coupling loop of the detector wafer is preferably arranged assymetrically to the rotational axis of the data carrier. As a result, an improved impedance adjustment is achieved between the coupling loop and the slot antenna.

The coupling loop of the detector wafer can surround a spindle hole of the data carrier.

This embodiment has the advantage that spacing tolerances between the coupling loop and the edge of the coating of the data carrier do not have a critical effect on the degree of coupling between the coupling loop and the slot antenna and the centre of mass of the data carrier essentially remains the same.

The coupling loop of the detector wafer can also be arranged outside a spindle hole of the data carrier.

As a result, the optimum for the impedance adjustment between the coupling loop of the detector wafer and that of the slot antenna can be calculated and set very precisely.

The coupling loop of the detector wafer can be of circular or oval shape or have a shape that allows an optimal adjustment on the given surface to the chip and the slot antenna.

This allows a simplification of the calculation of the impedance adjustment between the coupling loop and the slot antenna and, as a result, foreseeable reproducible results for practical implementation.

The coupling loop of the detector wafer can be kidney-shaped and adjusted to the inner circumference of the coating.

This allows both the achievement of a particularly high degree of coupling and, at the same time, the influencing of the resonance frequency of the slot antenna.

A counterweight, preferably of the same shape, can be placed opposite the coupling loop of the detector wafer mirror-symmetrically to a mirror axis that runs through the rotational axis.

It is possible, as a result, to compensate for displacements of the centre of mass of the data carrier caused by the asymmetric arrangement of the detector wafer. Furthermore, the counterweight could also be configured as an additional detector wafer which uses the same slot antenna.

The dipole antenna arranged in the case or packaging of the data carrier can be coupled to the coupling loop of the detector wafer, which is arranged assymetrically to the rotational axis of the data carrier.

One and the same coupling loop which is arranged assymetrically to the rotational axis of the data carrier and is used to couple to slot antenna without the cover or packaging, is additionally used here to couple to the dipole antenna when the data carrier is located in the case or packaging. However, the degree of coupling and therefore the reading range is dependent on the orientation of the data carrier in the case or packaging and therefore, the assymetrically and therefore eccentrically arranged coupling loop on the data carrier.

The dipole antenna arranged in the case or packaging of the data carrier can be coupled to the slot antenna of the data carrier.

In this embodiment the slot antenna functions as an intermediary or parasitic element between the coupling loop on the data carrier and the coupling region of the dipole antenna. The advantage of this embodiment lies in the fact that the reading range is independent from the orientation of the data carrier in the case or packaging.

The dipole antenna arranged in the case or packaging of the data carrier can also be coupled both to the coupling loop of the detector wafer, which is arranged assymetrically to the rotational axis of the data carrier, and to the slot antenna of the data carrier.

In this embodiment, by directly coupling to the coupling loop, the advantages of a large reading range are linked with the advantages of a coupling which is independent from the orientation of the data carrier in the case or packaging.

Alternatively, in the case of a chip with a plurality of connections, at least two separate coupling loops could be connected, of which one is arranged centrally and the other eccentrically on the data carrier. The central coupling loop then allows coupling to the dipole antenna which is independent from the orientation of the data carrier and the eccentric coupling loop allows coupling to the slot antenna.

As a result, there is a multiplicity of combination possibilities of the various antennae and therefore reading ranges. A data carrier with the described detector wafer, independently of whether the coupling loop is arranged symmetrically to the centre of the data carrier, that is to say concentrically, or asymmetrically to the centre of the data carrier, that is to say eccentrically, and independently of whether an amplifying antenna is coupled to the coupling loop, always has an independent magnetic antenna which can be read in the near field with a magnetic reading antenna as a result of the coupling loop of the detector wafer. Electrically conductive objects located in the vicinity only exert a small, practically negligible damping. As a result, a reading contact with a magnetic reading antenna in the near field is ensured under practical conditions. The small reading range that is linked with this has the advantage that influences from neighbouring data carriers are small and reader devices either get by without anti-collision processes or, if using anti-collision processes, only need to take account of a few collisions and only a short time period is needed for a secure read operation.

A data carrier for which the slot antenna formed by the data carrier itself also serves as an amplifying antenna can additionally be read in the far field with a magnetic or electric reading antenna. Approximately half of the maximum reading range that could otherwise only be achieved with a separate amplifying antenna, in a case or packaging and configured as a dipole antenna, could be detected as the reading range of the data carrier configured in this manner, that is to say without any additional material outlay whatsoever and without a data carrier case or packaging. As a result of this reading variant, manipulation attempts can therefore be detected in which a data carrier is removed from the case in the assumption that this could prevent readability in the far field.

A data carrier with the described detector wafer, independently of whether the coupling loop is arranged symmetrically to the centre of the data carrier, that is to say concentrically, or asymmetrically to the centre of the data carrier, that is to say eccentrically, and which is coupled in a case or packaging to an amplifying antenna which is configured as a dipole antenna, achieved the maximum reading range in the far field as can also be achieved with standard detector wafers. This reading range was substantially independent of whether the dipole antenna served as the amplifying antenna exclusively or in combination with the slot antenna and whether the slot antenna acted as an additional coupler between the coupling loop and the slot antenna.

In addition, the reading range numerical data is merely measured values from an experimental assembly. Higher reading ranges are also possible by using directional read antennae and increasing the reading transmission power and the receiver sensitivity.

In a further embodiment, the data carrier case can be formed as a book with a pocket, a dipole antenna coupled to the coupling loop of the detector wafer of the data carrier can be arranged in or on a cover page or a book cover and a further detector wafer, which is coupled to the same dipole antenna, can be arranged in or on the cover page or the book cover.

The invention is explained below using exemplary embodiments which are shown in the drawing. In the drawing,

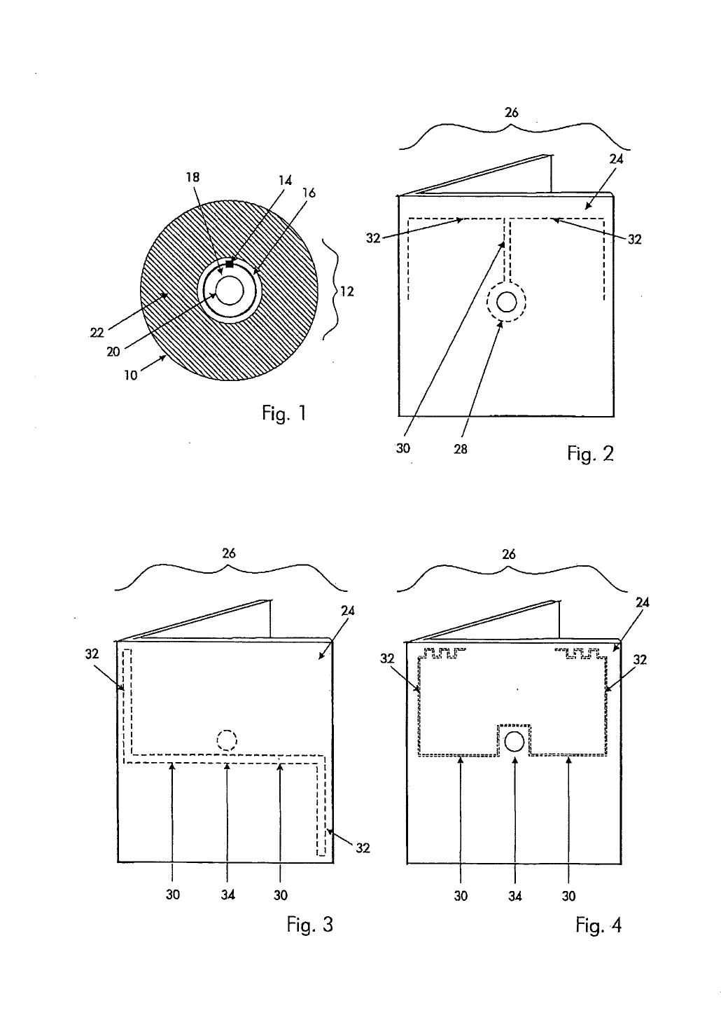

FIG. 1 shows a rotating data carrier with a detector wafer consisting of a chip and a central coupling loop,

FIG. 2 shows a data carrier case with a dipole antenna consisting of a central loop, feed and adjustment regions and angled transmitters,

FIG. 3 shows a data carrier case with a dipole antenna consisting of a coupling region, feed and adjustment regions and transmitters which are arranged in opposite directions,

FIG. 4 shows a data carrier case with a dipole antenna consisting of a coupling region, feed and adjustment regions and transmitters which are arranged in the same direction,

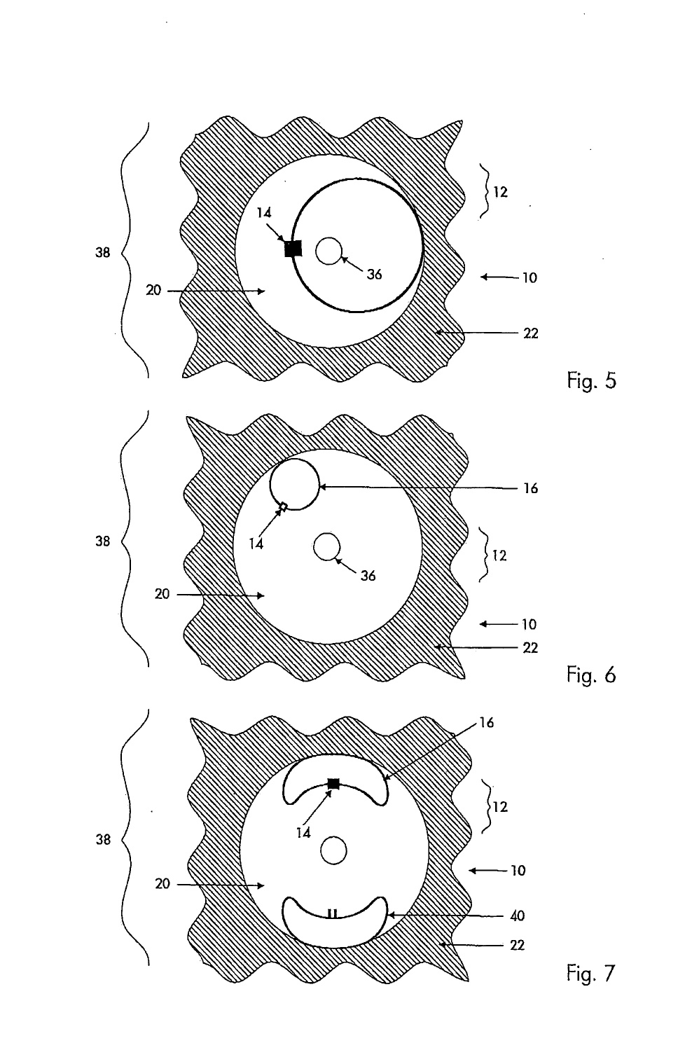

FIG. 5 shows a rotating data carrier with a detector wafer consisting of a chip and an eccentric coupling loop which surrounds a spindle hole,

FIG. 6 shows a rotating data carrier with a detector wafer consisting of a chip and an eccentric coupling loop which is arranged outside a spindle hole,

FIG. 7 shows a rotating data carrier with a detector wafer consisting of a chip and an eccentric, kidney-shaped coupling loop which is arranged outside a spindle hole, and a counterweight, and

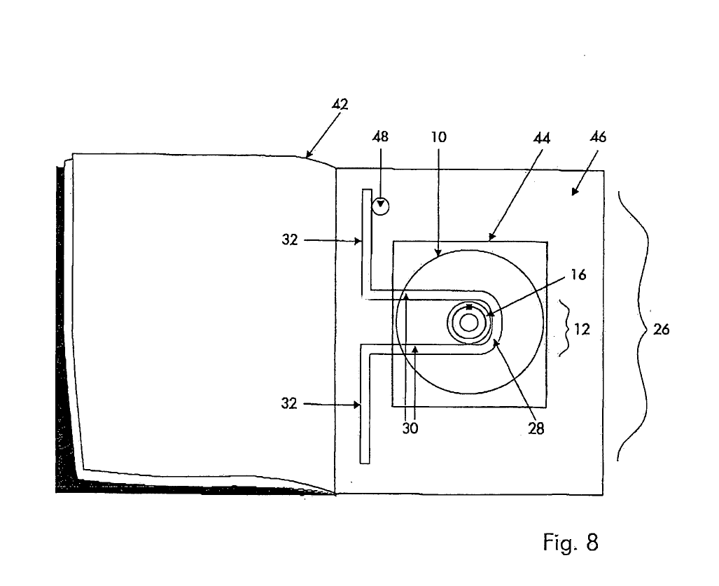

FIG. 8 shows a data carrier case which is configured as a book with a pocket, with a dipole antenna consisting of a central loop, feed and adjustment regions and transmitters,

FIG. 1 shows a rotating data carrier 10 with a detector wafer 12 consisting of a chip 14 and a central coupling loop 16 which is connected to the chip 14. The chip 14 with the coupling loop 16 is located on a plastic film 18, which is adhesively bonded onto the uncoated centre 20 of the data carrier 10. The coupling loop 16 itself forms a small magnetic antenna for the magnetic components of an electromagnetic field, and its transmission properties are only influenced insubstantially by surrounding, conductive components, namely a metallic coating 22 of the data carrier 10. The coupling loop 16 can therefore be coupled directly to a magnetic reading antenna in the near field or coupled to a passive amplifying antenna by means of a low-resistance coupling region of this amplifying antenna and read with a magnetic or electric reading antenna in the far field.

FIG. 2 shows a data carrier case 24 with a dipole antenna 26 which is configured as an amplifying antenna and consists of a central loop 28, feed and adjustment regions 30 and angled transmitters 32. If the data carrier 10 with the detector wafer 12 according to FIG. 1 is inserted into the data carrier case 24 according to FIG. 2, the coupling loop 16 of the detector wafer 12 is coupled to the central loop 28 of the dipole antenna 26 and the central loop 28 is in turn connected to the actual transmitters 32 of the dipole antenna 26 by means of the parts of the dipole antenna 26 which run parallel and flat with respect to the coating 22 of the data carrier 10 and act as feed and adjustment regions 30. These transmitters 32 run along the edge of the data carrier case 24 and turn off symmetrically at the corners, where they run out on the edge of the data carrier case 24.

In the edge region of the data carrier case 24 there is a sufficient spacing for the coating 22, so that the dipole antenna 26 can receive or transmit the electrical components of an electromagnetic field here.

FIG. 3 shows a data carrier case 24 with a first variant of the dipole antenna 26. This consists of a straight coupling region 34 which is offset from the centre, feed and adjustment regions 30 and transmitters 32 which are arranged in opposite directions.

FIG. 4 shows a data carrier case 24 with a second variant of the dipole antenna 26. This consists likewise of a coupling region 34 which is offset from the centre, feed and adjustment regions 30, but transmitters 32 which are arranged in the same direction. The transmitters 32 first run upwards along the left and right sides of the data carrier case 24, which are shown in FIG. 4, turn off perpendicularly at the upper edges and continue to extend partially along the upper side of the data carrier case 24. The ends of the transmitters 32 have a meandering shape for electrical extension.

FIG. 5 shows a rotating data carrier 10 with a detector wafer 12 consisting of a chip 14 and an eccentric coupling loop 16 which surrounds a spindle hole 36. An amplifying antenna which is coupled to the coupling loop 16 is a slot antenna 38 here, which is formed by the coating 22 of the data carrier 10 in connection with the circular, uncoated centre 20 of the data carrier 10 itself. The circular, uncoated centre 20 of the data carrier 10 is a widened slot whose low-resistance region is coupled to the coupling loop 16 of the detector wafer 12. Since the entire internal circumference of the circular, uncoated centre 20 of the data carrier 10 is to be considered an equivalent, low-resistance region, a coupling is achieved if the coupling loop 16 is merely arranged eccentrically with respect to the rotational axis of the data carrier 10. The degree of coupling and the adjustment of the impedance can be set by the extent of the eccentricity and the shape of the coupling loop 16.

FIG. 6 shows a rotating data carrier 10 with a detector wafer 12 consisting of a chip 14 and a first variant of the eccentric coupling loop 16. The coupling loop 16 with a circular shape is arranged outside a spindle hole 36 here.

FIG. 7 shows a rotating data carrier 10 with a detector wafer 12 consisting of a chip 14 and a second variant of the eccentric coupling loop 16. The coupling loop 16 is likewise arranged outside a spindle hole 36 here, but has a kidney shape which is matched to the inner circumference of the coating 22. Moreover, the coupling loop 16 is assigned a counterweight 40 of the same shape, which is arranged mirror-symmetrically with respect to a mirror axis which runs through the rotational axis.

FIG. 8 shows a data carrier case which is configured as a book 42 with a pocket 44, with a dipole antenna 26 consisting of a central loop 28, feed and adjustment regions 30 and transmitters 32. The dipole antenna 26 is located on or in the cover page which supports the pocket 44 or on or in the book cover 46. In a similar manner to the embodiment according to FIG. 2, a coupling between the coupling loop 16 of the detector wafer 12 on the data carrier 10 and the central loop 28 of the dipole antenna 26 takes place when the data carrier 10 is in the pocket 44. In addition, the cover page or the book cover 46 can also be equipped with its own detector wafer 48 which is coupled to the same dipole antenna 26. Both detector wafers 12; 48 can be read independently of each other by using a conventional anti-collision method.

The design according to the invention makes the following applications possible in commerce, libraries and archives.

Owing to the large reading range, inventories of the data carrier contents can be taken without the data carriers needing to be taken out of the case, packaging or shelves. Adjacent data carriers whose detector wafers are in the same reading field can be differentiated by means of a conventional anti-collision method.

Despite the relatively small construction compared to books, a similarly high reading range can be achieved even with just data carriers or with data carriers stored in cases.

The reading range of data carriers with detector wafers with a small reading range can be increased in combination with cases or packaging.

When the data carrier is used as a slot antenna, the reading range can be increased considerably compared to the reading range of just the detector wafer, without additional material outlay. Concealed or scattered data carriers can be detected.

Limited evaluation of the near field within a shelf can be used to register the removal of data carriers and then evaluation of the far field can be used to monitor further transportation. In this manner it can be determined whether a data carrier has then been registered and checked out properly in the till or lending area or may have been stolen. Even manipulation by wrapping the data carrier in screening material can be detected, in that an interruption of the reading contact with a data carrier is established without the latter being properly checked out after registration in the till or lending area, by means of continuous, large-scale monitoring.

1. Rotating data carrier (10) with detector wafer (12), wherein the detector wafer (12) consists of a chip (14) and a magnetic coupling loop (16) connected to the chip (14), which loop is arranged on the central uncoated region (20) of the data carrier (10).

2. Rotating data carrier (10) with detector wafer (12) according to claim 1, wherein the detector wafer (12) is arranged on a plastic film (18) which is bonded to the data carrier (10).

3. Rotating data carrier (10) with detector wafer (12) according to claim 1, wherein the coupling loop (16) of the detector wafer (12) is coupled to an amplifying antenna.

4. Rotating data carrier (10) with detector wafer (12) according to claim 3, wherein the amplifying antenna is configured as a dipole antenna (26).

5. Rotating data carrier (10) with detector wafer (12) according to claim 4, wherein the dipole antenna (26) is arranged in a case (24) or packaging of the data carrier (10).

6. Rotating data carrier (10) with detector wafer (12) according to claim 5, wherein the dipole antenna (26) is arranged so as not to be visible on a reverse side of a printed inlay in the case (24), on the reverse side of the holder for the data carrier in the case (24) or on an antenna carrier inserted between the holder for the data carrier and the printed inlay in the case (24).

7. Rotating data carrier (10) with detector wafer (12) according to claim 4, wherein the dipole antenna (26) consists of a coupling region (28; 34) running in the centre or close to the centre of the case (24) or packaging and transmitters (32) running along the edges of the case (24) or packaging.

8. Rotating data carrier (10) with detector wafer (12) according to claim 4, wherein the amplifying antenna is formed as a slot antenna (38), the slot being formed by the central uncoated region (20) of the data carrier (10) itself.

9. Rotating data carrier (10) with detector wafer (12) according to claim 8, wherein the coupling loop (16) of the detector wafer (12) is arranged asymmetrically or eccentrically to the rotational axis of the data carrier (10).

10. Rotating data carrier (10) with detector wafer (12) according to claim 8, wherein the coupling loop (16) of the detector wafer (12) surrounds a spindle hole (36) of the data carrier (10).

11. Rotating data carrier (10) with detector wafer (12) according to claim 8, wherein the coupling loop (16) of the detector wafer (12) is arranged outside a spindle hole (32) of the data carrier (10).

12. Rotating data carrier (10) with detector wafer (12) according to claim 8, wherein the coupling loop (16) of the detector wafer (12) is of circular or oval shape or has a shape that allows an optimal matching on the given surface to the chip (14) and the slot antenna (38).

13. Rotating data carrier (10) with detector wafer (12) according to claim 8, wherein the coupling loop (16) of the detector wafer (12) is kidney-shaped and is matched to the inner circumference of the coating (22).

14. Rotating data carrier (10) with detector wafer (12) according to claim 13, wherein a counterweight (40), preferably of the same shape, is placed opposite the coupling loop (16) of the detector wafer (12) mirror-symmetrically to a mirror axis that runs through the rotational axis of the data carrier (10).

15. Rotating data carrier (10) with detector wafer (12) according to claim 4, wherein the dipole antenna (26) arranged in the case (24) or packaging of the data carrier (10) is coupled to the coupling loop (16) of the detector wafer (12), which is arranged assymetrically to the rotational axis of the data carrier (10).

16. Rotating data carrier (10) with detector wafer (12) according to claim 4, wherein the dipole antenna (26) arranged in the case (24) or packaging of the data carrier (10) is coupled to the slot antenna (38) of the data carrier (10).

17. Rotating data carrier (10) with detector wafer (12) according to claim 4, wherein the dipole antenna (26) arranged in the case (24) or packaging of the data carrier (10) is coupled both to the coupling loop (16) of the detector wafer (12), which is arranged assymetrically to the rotational axis of the data carrier (10), and to the slot antenna (38) of the data carrier (10).

18. Rotating data carrier (10) with detector wafer (12) according to claim 4, wherein the case is formed as a book (42) with a pocket (44), in that a dipole antenna (26) coupled to the coupling loop (16) of the detector wafer (12) is arranged in or on a cover page or a book cover (46) and in that a further detector wafer (48), which is coupled to the same dipole antenna (26), is arranged in or on the cover page or the book cover (46).
